(19) United States
(12) Patent Application Publication
(10) Pub. No.: US 2026/0153748 A1
(43) Pub. Date: Jun. 4, 2026

(54) Projection System Including a 3-D Extendable Projection Surface

(71) Applicant: Disney Enterprises, Inc., Burbank, CA (US)

(72) Inventors: Charles Jacob Sedor, Burbank, CA (US); Brianna Lee Pfost, Burbank, CA (US)

(21) Appl. No.: 18/967,217

(22) Filed: Dec. 3, 2024

(51) Int. Cl. G02B 30/52

(52) U.S. Cl. CPC G02B 30/52

(57) ABSTRACT

A system includes a computing platform having a hardware processor and a system memory storing software code, as well as a projection unit controlled by the computing platform, the projection unit including a three-dimensional (3-D) extendable projection surface having an extending end and a non-extending end. The hardware processor is configured to execute the software code to receive an activation signal, extend, in response to receiving the activation signal, the extending end of the 3-D extendable projection surface away from the non-extending end, illuminate the 3-D extendable projection surface, and produce a 3-D visual effect on the extended and illuminated 3-D extendable projection surface that is at least one of:
(i) synchronized to a predetermined entertainment, (ii) interactively responsive to an action by a person at a venue including the 3-D extendable projection surface, or (iii) responsive to a location of the person within the venue.

### BACKGROUND

Entertainment props suitable for use in generating large imposing visual effects in a scene, such as mountains, waterfalls and cyclonic weather phenomena, for example, are typically large static projection surfaces. Introducing such objects into a scene, and removing them after the visual effect they help to produce is no longer desired, can be a cumbersome physical relocation process that may be observable to viewers, thereby undesirably breaking immersion of those viewers in an entertainment experience that includes the visual effect. In other words, although a large static projection surface can satisfy projection needs to create a desired imposing visual effect, the lighting requirements for the scene typically result in the disadvantage that a prop of that scale is visible to viewers prior to the start of the visual effect, is visible to viewers after the visual effect is no longer featured in the scene, or is visible to viewers as it is moved into or out of the scene. Thus, there is a need in the art for a projection solution capable of appearing to generate a visual effect organically, in the midst of a well-lighted scene, as well as to cause that visual effect to disappear from view without breaking immersion of viewers of an entertainment including the visual effect.

### BRIEF DESCRIPTION OF THE DRAWINGS

FIG. 1 shows a diagram of a projection system including a three-dimensional (3-D) extendable projection surface, according to one exemplary implementation;

FIG. 2A shows a more detailed diagram of an exemplary projection unit including a 3-D extendable projection surface suitable for use in the system of FIG. 1, in an extended state, according to one implementation;

FIG. 2B shows the exemplary 3-D extendable projection surface of FIG. 2A in a retracted state, according to one implementation;

FIG. 2C shows the exemplary 3-D extendable projection surface of FIG. 2A in a retracted state, according to another implementation;

FIG. 3 shows a more detailed diagram of an exemplary sensor unit suitable for use with the system of FIG. 1, according to one implementation; and

FIG. 4 shows a flowchart presenting an exemplary method for use by a system including a 3-D extendable projection surface, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals.

As stated above, entertainment props suitable for use in generating large imposing visual effects in a scene, such as mountains, waterfalls and cyclonic weather phenomena, for example, are typically large static projection surfaces. Introducing such objects into a scene, and removing them after the visual effect they help to produce is no longer desired, can be a cumbersome physical relocation process that may be observable to viewers, thereby undesirably breaking immersion of those viewers in an entertainment experience that includes the visual effect. In other words, although a large static projection surface can satisfy projection needs to create a desired imposing visual effect, the lighting requirements for the scene typically result in the disadvantage that a prop of that scale is visible to viewers prior to the start of the visual effect, is visible to viewers after the visual effect is no longer featured in the scene, or is visible to viewers as it is moved into or out of the scene, which, for some visual effects may need to occur frequently.

The present application is directed to projection systems including three-dimensional (3-D) extendable projection surfaces and methods for their use that address and overcome the deficiencies in the conventional art. The novel and inventive concepts disclosed in the present application advance the state-of-the-art by providing a projection solution capable of appearing to generate a visual effect organically, by realistically moving and shaping a 3-D projection surface as it is deployed in the midst of a well-lighted scene, as well as to cause that visual effect to disappear from view without breaking immersion of viewers of an entertainment including the visual effect. The visual effect produced by the novel and inventive 3-D extendable projection surface disclosed in the present application has the additional advantage of being viewable in-the-round to full effect. That is to say, the resultant visual effect may be viewed from multiple or moving perspectives concurrently. Moreover, the present solution may advantageously be implemented as substantially automated systems and methods.

As defined in the present application, the terms “automation,” “automated” and “automating” refer to systems and processes that do not require human intervention. Although in some implementations a human operator may supervise the systems using the methods described herein, that human involvement is optional. Thus, the methods described in the present application may be performed under the control of hardware processing components of the disclosed automated systems.

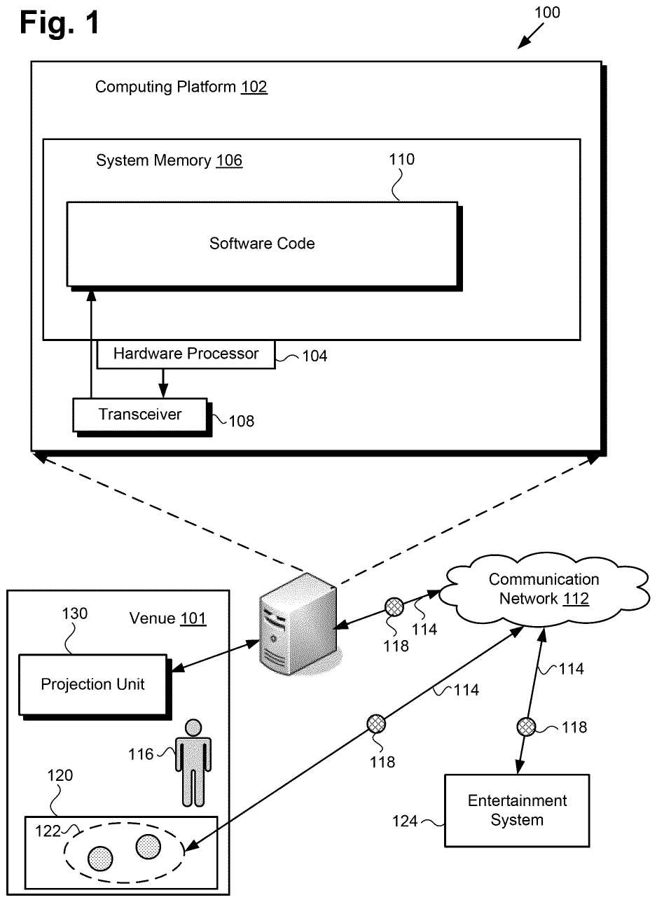

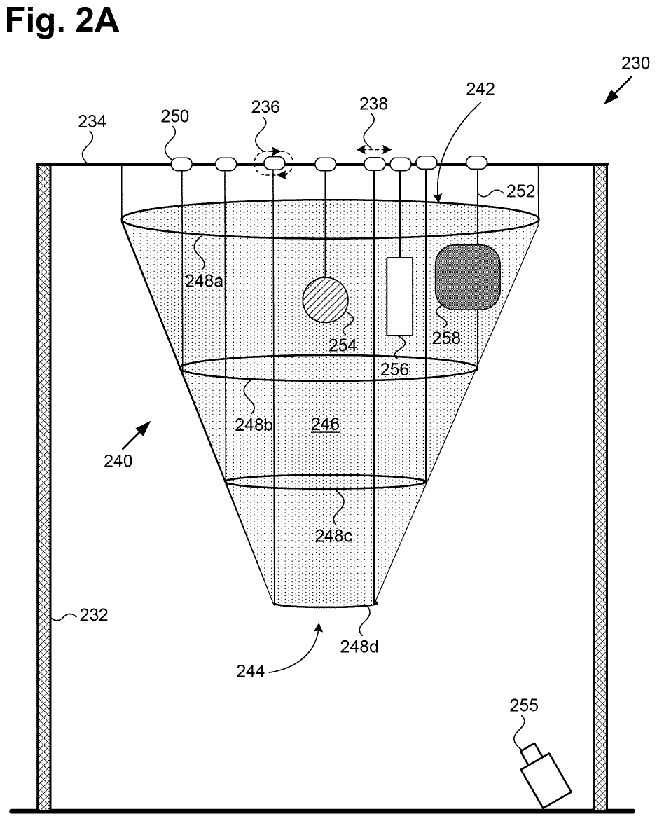

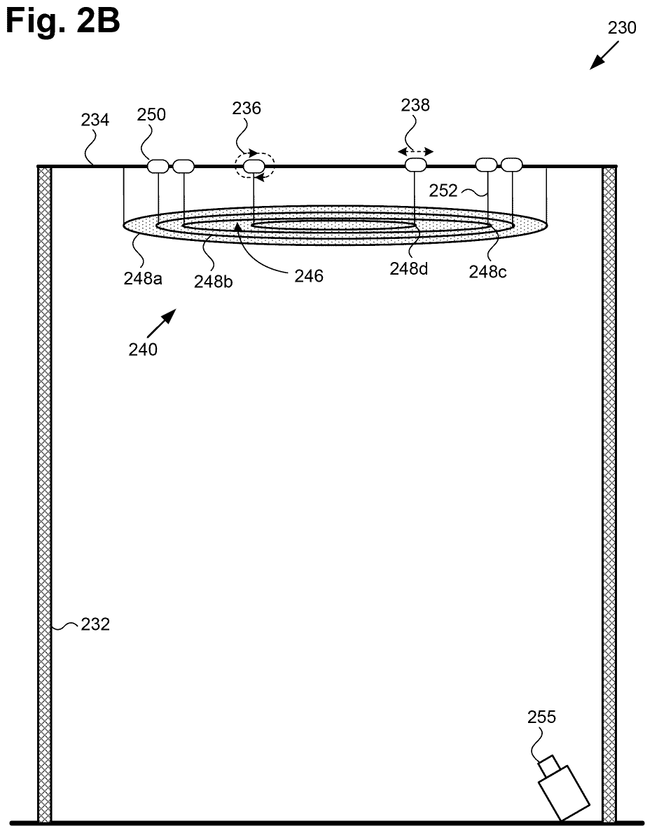

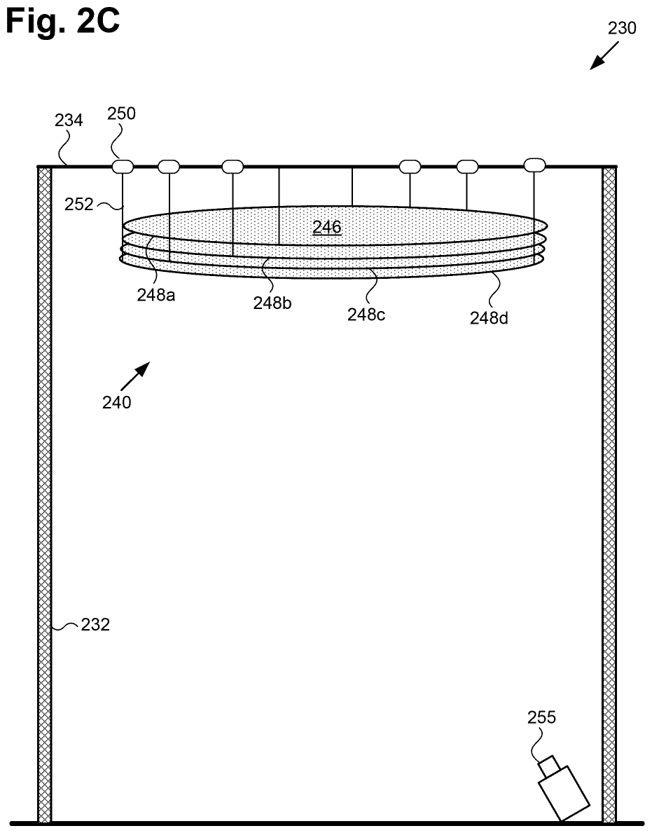

FIG. 1 shows a diagram of a projection system (hereinafter “system 100”) including a 3-D extendable projection surface, according to one exemplary implementation. As shown in FIG. 1, system 100 includes computing platform 102 having hardware processor 104, transceiver 108 and system memory 106 implemented as a computer-readable non-transitory storage medium storing software code 110. In addition, system 100 includes projection unit 130 located in venue 101 for an entertainment, such an animation, video presentation, theatrical performance, or multi-media presentation, to name a few examples. The entertainment may be presented in conjunction with a show, a ride, or an interactive experience, to name a few examples. It is noted that although not shown in FIG. 1, projection unit 130 includes a 3-D extendable projection surface, which is described in detail below by reference to FIGS. 2A and 2B. It is further noted that although FIG. 1 depicts projection unit 130 as being controlled by, but physically separate from, computing platform 102, that representation is provided merely by way of example. In some implementations computing platform 102 and projection unit 130 may be integrated into a single apparatus. Thus, in those implementations, system 100 may be located in venue 101.

As further shown in FIG. 1, system 100 is implemented within a use environment including sensor unit 120 including one or more sensors 122 (hereinafter “sensor(s) 122”) located in venue 101, entertainment system 124 configured to control the presentation of a predetermined entertainment, and communication network 112 providing network communication links 114 communicatively coupling sensor unit 120 and entertainment system 124 with computing platform 102 of system 100. It is noted that, in some implementations, sensor unit 120 may be included as a feature of system 100, while in other implementations sensor unit 120 may be a feature of venue 101 capable of communicating with system 100. It is further noted that, in some implementations, entertainment system 124 may be included as a feature of system 100, or entertainment system 124 may be a macro-control system, such as a ride system or an audio/video control system that may include lighting and other equipment supporting a show. Also shown in FIG. 1 is activation signal 118 received by system 100 from sensor unit 120 or from entertainment system 124 via communication network 112 and network communication links 114.

Although the present application refers to software code 110 as being stored in system memory 106 for conceptual clarity, more generally, system memory 106 may take the form of any computer-readable non-transitory storage medium. The expression “computer-readable non-transitory storage medium,” as defined in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Moreover, in some implementations, system 100 may utilize a decentralized secure digital ledger in addition to system memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

It is noted that although FIG. 1 depicts software code 110 as being stored in its entirety in a single instantiation of system memory 106, that representation is also merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100.

Hardware processor 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for artificial intelligence processes such as machine learning.

Transceiver 108 may be implemented as a wireless communication unit configured for use with one or more of a variety of wireless communication protocols. For example, transceiver 108 may include a fourth generation (4G) wireless transceiver, a 5G wireless transceiver, or 4G and 5G wireless transceivers. In addition, or alternatively, transceiver 108 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods.

In some implementations, computing platform 102 may correspond to one or more web servers accessible over a packet-switched network such as the Internet, for example. Alternatively, computing platform 102 may correspond to one or more computer servers supporting a wide area network (WAN), a local area network (LAN), or included in another type of private or limited distribution network. In addition, or alternatively, in some implementations, system 100 may utilize a local area broadcast method, such as User Datagram Protocol (UDP) or Bluetooth, for instance. Furthermore, in some implementations, computing platform 102 may be implemented virtually, such as in a data center. For example, in some implementations, computing platform 102 may be implemented in software, or as virtual machines. Moreover, in some implementations, communication network 112 may be a high-speed network suitable for high performance computing (HPC), for example a 10 GigE network or an Infiniband network.

Alternatively, in some implementations computing platform 102 may take the form of a of a personal computing device, such as a desktop computer or any other suitable mobile or stationary computing system that implements data processing capabilities sufficient to support connections to communication network 112 and implement the control of projection unit 130 ascribed to computing platform 102 herein. For example, in other implementations, computing platform 102 may take the form of a laptop computer, tablet computer, or smartphone, for example.

FIG. 2A shows a more detailed diagram of projection unit 230 including exemplary 3-D extendable projection surface 240 (in an extended state) suitable for use in system 100, according to one implementation. According to the exemplary implementation shown in FIG. 2A, projection unit 230 includes 3-D extendable projection surface 240 and support structure 232 having horizontal support arm 234 for supporting 3-D extendable projection surface 240.

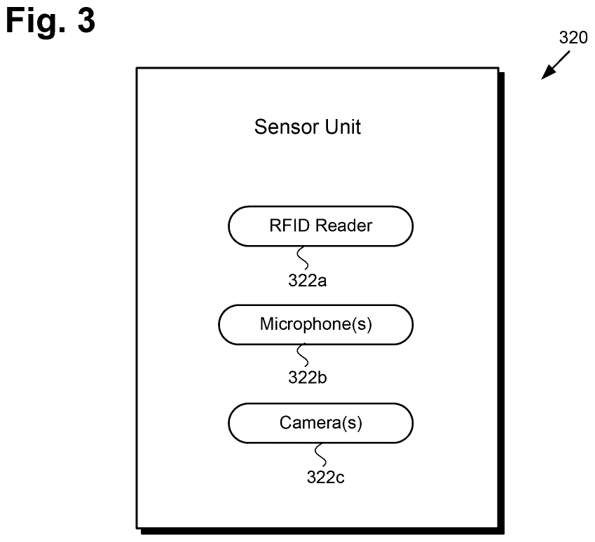

As further shown in FIGS. 2A, 3-D extendable projection surface 240 includes non-extending end 242 attached to horizontal support arm 234 of support structure 232 so as to be substantially stationary, and extending end 244 configured to extend away from non-extending end 242 during deployment of 3-D extendable projection surface 240. In addition, 3-D extendable projection surface 240 is shown to include deformable textured material 246 providing an exterior of 3-D extendable projection surface 240, multiple structural elements 248a, 248b, 248c and 248d (hereinafter “structural elements 248a-248d”) affixed to the inner surface of deformable textured material 246, and multiple actuators 250 each including a respective connector 252 attached to one of structural elements 248b, 248c and 248d.

Although the exemplary implementation shown in FIG. 2A is described as including four structural elements 248a-248d, one of which, i.e., structural element 248a is depicted as being located at substantially stationary non-extending end 242, that representation is merely provided by way of example. In other implementations, structural elements corresponding to structural elements 248a-248b may include as few as two structural elements, e.g., one structural element at each of non-extending end 242 and extending end 244, or may include three structural elements, four structural elements, or more than four structural elements. In addition, in some implementations, all structural elements included by 3-D extendable projection surface 240, i.e., structural element 248a as well as structural elements 248b, 248c and 248d, may be attached to a respective actuator by a respective connector. Moreover, it is noted that, when 3-D extendable projection surface 240 is extended, as shown in FIG. 2A, structural elements 248a-248d are located at different respective heights along the interior of3-D extendable projection surface 240.

Also shown in FIG. 2A are one or more optional internal lighting elements 254 (hereinafter “internal lighting element(s) 254”) of 3-D extendable projection surface 240, optional one or more external lighting elements 255 (hereinafter “external lighting element(s) 255”) of projection unit 120/230, and optional object 256, which when activated, can be used to produce shadow 258 within 3-D extendable projection surface 240, but visible through the exterior of 3-D extendable projection surface 240 provided by deformable textured material 246. It is noted that when not activated, optional internal lighting element(s) 254 and optional object 256 may not be visible through deformable textured material 246. It is further noted that in various implementations, 3-D extendable projection surface 240 may be configured for internal illumination using optional internal lighting element(s) 254, may be lighted externally by external lighting element(s) 255 illuminating the exterior of 3-D extendable projection surface 240 provided by deformable textured material 246, or may be both internally and externally illuminated.

It is noted that projection unit 230 corresponds in general to projection unit 130, in FIG. 1, and those corresponding features may share any of the characteristics attributed to either corresponding feature by the present disclosure. That is to say, although not shown in FIG. 1, projection unit 130 includes support structure 232 having horizontal support arm 234 and 3-D extendable projection surface 240 having any of the elements shown in and described by reference to FIG. 2A.

Exemplary 3-D extendable projection surface 240 is operable using overhead rigging provided by actuators 250 including connectors 252 to actuate an internal skeleton provided by structural elements 248a-248d in the desired shape of a 3-D object which is to be created and illuminated. The rigging is connected to structural elements 248b, 248c and 248d such that the downward extension of connectors 252 in the form of exemplary cables, via exemplary winches of actuators 250 controlled by computing platform 102, may control the size, shape, and behavior of 3-D extendable projection surface 240 so as to cause 3-D projection surface to move realistically as it is deployed.

Deformable textured material 246 may include a structural-base theatrical fabric layered with fire resistant batting material, such a Dacron® for example, to enhance the dimension of the surface, lending itself to the look of a desired object shape while obscuring internal shadows of smaller mechanisms and connectors. Alternatively, deformable textured material 246 may include cotton batting, a cling-wrap type material, spandex, or iron wool, to name a few examples. Structural elements 248a-248d may take the form of hoops or rings, for example, which in some implementations may be made of a translucent material, such as acrylic rod, to allow for light from internal lighting element(s) 254 to pass through structural elements 248a-248d. Alternatively, in some use cases, one or more of structural elements 248a-248d may be formed of a material such as fiberglass, carbon fiber, or any other opaque material capable of serving as structural elements 248a-248d, while having sufficiently small dimensions to be visually obscured by the exterior of 3-D extendable projection surface 240 provided by deformable textured material 246.

In some implementations, optional object 256 may be or include an opaque character-facsimile made from a sock of scrim that travels up and down within 3-D extendable projection surface 240 to cast shadow 258 and add to the illusion of the character traveling through 3-D extendable projection surface 240 as 3-D extendable projection surface 240 is deployed and illuminated from within by internal lighting element(s) 254, which may include one or more strobe lights for example. The combination of structural elements 248a-248d, deformable textured material 246 and actuators 250 including connectors 252 allow for an accordion-like and/or telescoping deployment of 3-D extendable projection surface 240.

As shown in FIG. 2A, in some implementations, 3-D extendable projection surface 240, when extended, may be configured to assume a conical, a pyramidal, or a frustoconical shape, having extending end 244 providing the vertex and non-extending end 242 providing the base, wherein non-extending end 242 is situated above extending end 244. In those implementations, actuators 250, which may be rotary actuators such as winches 236, linear actuators 238 configured to slide along horizontal support arm 234 of support structure 232, or a combination thereof may be used to extend the length of connectors 252, in the form of exemplary cables, to lower extending end 244 away from non-extending end 242. Moreover, in some of those implementations, structural elements 248a-248d may be rings or hoops having progressively smaller dimensions, such as rings having progressively smaller diameters, or ellipses having progressively shorter major and minor axes, with structural element 248a of non-extending end having the largest dimensions and structural element 248d of extending end having the smallest dimensions. However, in other implementations, each of structural elements 248a-248d may have substantially the same dimensions, such as the same diameters, or major and minor elliptical axes of the same length.

The implementation of 3-D extendable projection surface 240 shown in FIG. 2A may be used to produce the illusion of an active cyclonic weather phenomenon, such as the formation of a tornado for example. It is noted that although FIG. 2A shows each of structural elements 248a-248d as having a single connection point for attachment to horizontal support arm 234 of support structure 232, that representation is merely provided in the interests of conceptual clarity. In various implementations, each of structural elements 248a-248d may have multiple connection points, while the deployment of each of structural elements 248b, 248c and 248d may be controlled using multiple actuators 250, such as three actuators 250 for each of structural elements 248b, 248c and 248d, or any other desired number of actuators 250 for each of structural elements 248b, 248c and 248d. It is further noted that the use of multiple actuators 250 to control the deployment of structural elements 248b, 248c and 248d advantageously enables those structural elements to shift or wobble relative to one another, thereby enhancing the realism with which a tornado or other cyclonic weather phenomenon appears to form and drop to earth.

FIG. 2B shows exemplary 3-D extendable projection surface 240 of FIG. 2A in a retracted state, according to one implementation. It is noted that any feature in FIG. 2B identified by a reference number identical to a reference number shown in FIG. 2A corresponds respectively to that previously described feature and may share any of its attributes. As is evident from FIG. 2B, in some implementations the deployment of 3-D extendable projection surface 240 depicted in FIG. 2A, may be reversed using actuators 250 to shorten the length of connectors 252 attached to each of structural elements 248b, 248c and 248d. Thus, in addition to enabling realistic deployment of 3-D extendable projection surface 240, the combination of structural elements 248a-248d, deformable textured material 246 and actuators 250 including connectors 252 allow for an accordion-like and/or telescoping retraction of 3-D extendable projection surface 240 such that 3-D extendable projection surface 240 may be hidden from the view of a person at a venue including 3-D extendable projection surface 240 and may be creatively deployed and illuminated to create a 3-D illusion on demand. In some examples, in the retracted state of 3-D extendable projection surface 240, structural element 248d (having the smallest dimensions of structural elements 248a-248d) completely nests within structural element 248c, structural element 248c (having dimensions smaller than structural element 248b) completely nests within structural element 248b, and structural element 248b (having dimensions smaller than structural element 248a) completely nests within structural element 248a such that structural elements 248a-248d are planar (i.e., lying in one plane) with respect to one another.

FIG. 2C shows exemplary 3-D extendable projection surface 240 of FIG. 2A in a retracted state, according to another implementation. It is noted that any feature in FIG. 2C identified by a reference number identical to a reference number shown in FIG. 2A of 2B corresponds respectively to that previously described feature and may share any of its attributes. As noted above, in some implementations, each of structural elements 248a-248d may have substantially the same dimensions, such as the same diameters, or major and minor elliptical axes of the same length. As is evident from FIG. 2C, in those implementations, retraction of 3-D extendable projection surface results in structural elements 248a-248d collapsing onto one another, rather than forming a nested retracted configuration as shown in FIG. 2B.

It is noted that although FIGS. 2A, 2B, and 2C depict implementations in which extending end 244 is extended away from non-extending end 242 by being lowered below non-extending end 242 using connectors 252 in the form of cables, that representation is merely provided by way of example. In other implementations, extending end 244 may be extended away from non-extending end 242 by being elevated above non-extending end 242 using connectors in the form of rods, for example, to create the illusion of a fountain or mountain, for example. In other words, in some implementations, when extended, extending end 244 of 3-D extendable projection surface may be situated above non-extending end 242.

In yet other implementations, extending end 244 may be extended laterally away from non-extending end 242 using connectors in the form of rods, for example, to simulate growth of a tree limb or other plant feature, or the act of reaching out by a hand of a character (e.g., a character embodied by a machine such as a robot). Moreover, in implementations other than the specific use case shown in FIGS. 2A, 2B and 2C, the respective dimensions of structural elements 248a-248d may progressively increase, may variably increase or decrease from structural element to structural element, or may be the same across some or all structural elements, while in various implementations one or more of structural elements 248a-248d may assume a shape or shapes other than rings or hoops (i.e., other than circular or elliptical). For example, one or more of structural elements 248a-248d may assume a shape of a rectangle, a square, a star, or a polygon.

FIG. 3 shows a more detailed diagram of sensor unit 320 suitable for use with system 100, in FIG. 1, according to one implementation. As shown in FIG. 3, sensor unit 320 may include one or any combination of RFID reader 322a, one or more microphones 322b (hereinafter “microphone(s) 322b”) and one or more cameras 322c (hereinafter “camera(s) 322c”). It is noted that the specific sensors shown to be included in sensor unit 120/320 are merely exemplary, and in other implementations, sensor unit 120/320 may include more, or fewer, sensors than RFID reader 322a, microphone(s) 322b and camera(s) 322c. Moreover, in other implementations, sensor unit 120/320 may include a sensor or sensors other than one or more of RFID reader 322a, microphone(s) 322b and camera(s) 322c (hereinafter also “sensor(s) 322a-322c”).

Sensor unit 320 and sensor(s) 322a-322c correspond respectively in general to sensor unit 120 and sensor(s) 122, in FIG. 1. Thus, sensor unit 120 and sensor(s) 122 may share any of the characteristics attributed to respective sensor unit 320 and sensor(s) 322a-322c by the present disclosure, and vice versa.

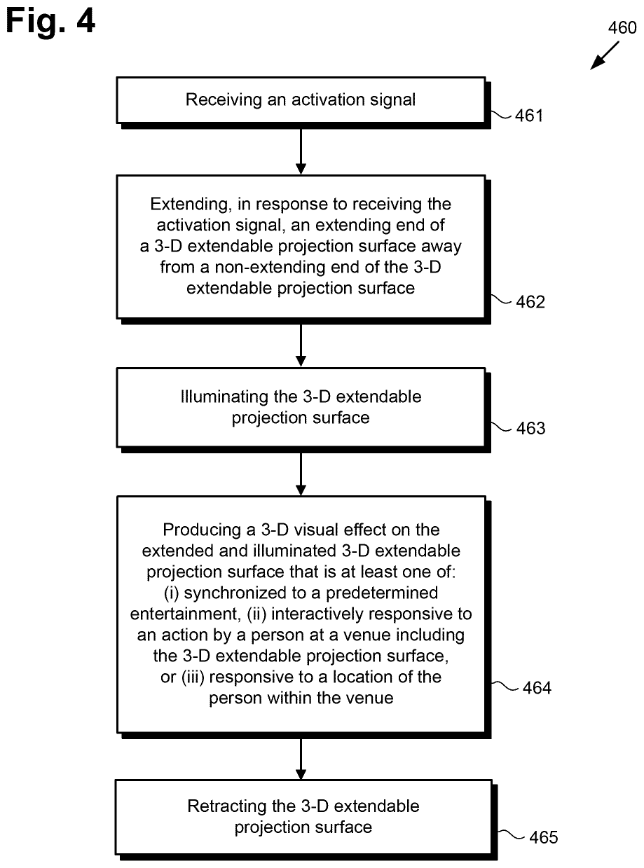

The operation of system 100 including projection unit 130/230 providing 3-D extendable projection surface 240 will be further described by reference to FIG. 4. FIG. 4 shows flowchart 460 presenting an exemplary method for use by a system including a 3-D extendable projection surface, according to one implementation. With respect to the actions outlined in FIG. 4, it is noted that certain details and features have been left out of flowchart 460 in order not to obscure the discussion of the inventive features in the present application.

Referring to FIG. 4 in combination with FIGS. 1, 2A and 3, flowchart 460 begins with receiving activation signal 118 (action 461). Activation signal 118 may be or include a trigger signal for initiating deployment of 3-D extendable projection surface 240 as part of the production of a 3-D visual effect for presentation to a person 116 at venue 101 in which projection unit 130/230 including 3-D extendable projection surface 240 is located. In some implementations, activation signal 118 may be received by computing platform 102 of system 100 from entertainment system 124, via communication network 112 and network communication links 114. Alternatively, in some implementations, activation signal 118 may be received by computing platform 102 of system 100 from sensor unit 120/320, based on data collected by one or more of sensor(s) 122/322a-322c, via communication network 112 and network communication links 114. In either use case, activation signal 118 may be received, in action 461, by software code 110, executed by hardware processor 104 of system 100.

Referring to FIG. 4 in combination with FIGS. 1 and 2A, flowchart 460 further includes extending, in response to receiving activation signal 118, extending end 244 of 3-D extendable projection surface 240 away from non-extending end 242 (action 462). As noted above by reference to FIG. 2A, in some implementations, 3-D extendable projection surface 240 may be configured to assume a conical, a pyramidal, or a frustoconical shape upon extension, having extending end 244 providing the vertex and non-extending end 242 providing the base, wherein non-extending end 242 is situated above or below extending end 244. In those implementations, actuators 250 of 3-D extendable projection surface 240, which may be rotary actuators and/or linear actuators, may be used to extend the length of connectors 252, in the form of exemplary cables, to lower extending end 244 away from non-extending end 242.

As further noted above, although FIG. 2A depicts an exemplary implementation in which extending end 244 is extended away from non-extending end 242 by being lowered below non-extending end 242 using connectors 252 in the form of cables, that representation is merely provided by way of example. In other implementations, extending end 244 may be extended away from non-extending end 242 by being elevated above non-extending end 242 using connectors in the form of rods, for example, to create the illusion of a fountain or mountain, for example. In yet other implementations, extending end 244 may be extended laterally away from non-extending end 242 using connectors in the form of rods, for example, to simulate growth of a tree limb or other plant feature, or the act of reaching out by a hand of a character. Regardless of the specific use case, extension of 3-D extendable projection surface 240 may be begun, in action 462, by software code 110, executed by hardware processor 104 of system 100, and using projection unit 130/230.

Continuing to refer to FIG. 4 in combination with FIGS. 1 and 2A, flowchart 460 further includes illuminating 3-D extendable projection surface 240 (action 463). It is noted that in various use cases 3-D extendable projection surface 240 may be illuminated at any time during the extension of 3-D extendable projection surface 240, or may be illuminated after the extension of 3-D extendable projection surface 240 has been completed and 3-D extendable projection surface 240 is fully deployed.

In some implementations, illumination of 3-D extendable projection surface 240 may be performed using optional external lighting element(s) 255 of projection unit 130/230, which may be or include one or more spot lights, one or more floodlights, or one or more spotlights and one or more floodlights. Alternatively, or in addition, illumination of 3-D extendable projection surface 240 may be performed using optional internal lighting element(s) 254 of 3-D extendable projection surface 240, which may be or include one or more strobe lighting elements.

In some implementations, and as also noted above, 3-D extendable projection surface 240 may include optional object 256 in the form of an opaque character-facsimile made from a sock of scrim that moves within 3-D extendable projection surface 240 to cast shadow 258 visible through the exterior of 3-D extendable projection surface 240. The continued extension and contemporaneous illumination of 3-D extendable projection surface 240, in action 463, may be performed by software code 110, executed by hardware processor 104 of system 100, and using projection unit 130/230.

Continuing to refer to FIG. 4 in combination with FIGS. 1 and 2A, flowchart 460 further includes producing a 3-D visual effect on the extended and illuminated 3-D extendable projection surface 240 that is at least one of: (i) synchronized to a predetermined entertainment, (ii) interactively responsive to an action by person 116 at venue 101 including 3-D extendable projection surface 240, or (iii) responsive to a location of person 116 within venue 101 (action 464). Action 464 may be performed by projection unit 130/230 under the control of software code 110, executed by hardware processor 104 of system 100, and may include projecting one or more images onto 3-D extendable projection surface 240.

In implementations in which the 3-D visual effect produced in action 464 is synchronized to a predetermined entertainment, that predetermined entertainment may be selected by entertainment system 124 and may be identified by activation signal 118 received by computing platform 102 of system 100 in action 461. Alternatively, referring further to FIG. 3, in implementations in which the 3-D visual effect produced in action 464 is responsive to a location of person 116 within venue 101, or to an action by person 116, that location, or that action, such as speech, movement, or a gesture, posture, or facial expression by person 116, for example, may be detected using one or more of RFID reader 322a, microphone(s) 322b, or camera(s) 322c of sensor unit 120/320. It is noted that, in some implementations, in addition to being responsive to a location of person 116 within venue 101 or an action by person 116, or as an alternative to being responsive to the location or the action, the 3-D visual effect produced in action 464 may be triggered by the presence of an object or item owned by person 116, or in the temporary possession of person 116.

In some use cases, the method outlined by flowchart 460 may conclude with action 464 described above. However, and as shown by FIG. 2B, in some implementations, 3-D extendable projection surface 240 may be a 3-D extendable and retractable projection surface. In those implementations, flowchart 460 may further include retracting 3-D extendable projection surface 240, either during the 3-D visual effect produced on 3-D extendable projection surface 240, or when the 3-D visual effect produced in action 464 ends (action 465). It is noted that the retracted state of 3-D extendable projection surface 240, i.e., either before a 3-D visual effect is to be produced or when the 3-D visual effect ends, advantageously hides 3-D extendable projection surface 240 from the view of person 116 when 3-D extendable projection surface 240 is not in use. Moreover, retraction of 3-D extendable projection surface 240 during the 3-D visual effect produced on 3-D extendable projection surface 240 may enhance the visual effect, for example by creating the illusion of a tornado that hops as it moves across the ground. Retraction of 3-D extendable projection surface 240, in action 465, may be performed by projection unit 130/230 under the control of software code 110, executed by hardware processor 104 of system 100.

With respect to the method outlined by flowchart 460, it is also noted that actions 461, 462, 463, and 464 (hereinafter “actions 461-464”), or actions 461-464 and 465, may be performed as an automated method from which human intervention may be omitted.

Thus, the present application discloses projection systems including 3-D extendable projection surfaces and methods for their use that address and overcome the deficiencies in the conventional art. The novel and inventive concepts disclosed in the present application advance the state-of-the-art by providing a projection solution capable of appearing to generate a visual effect organically, by realistically moving and shaping a 3-D projection surface as it is deployed in the midst of a well-lighted scene, as well as to cause that visual effect to disappear from view without breaking immersion of viewers of an entertainment including the visual effect. The visual effect produced by the novel and inventive 3-D extendable projection surface disclosed in the present application has the additional advantage of being viewable in-the-round to full effect. That is to say, the resultant visual effect may be viewed from multiple or moving perspectives concurrently.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a system memory storing a software code; and
a projection unit controlled by the computing platform, the projection unit including a three-dimensional (3-D) extendable projection surface having an extending end and a non-extending end;
the hardware processor configured to execute the software code to:
receive an activation signal;
extend, in response to receiving the activation signal, the extending end of the 3-D extendable projection surface away from the non-extending end;
illuminate the 3-D extendable projection surface; and
produce a 3-D visual effect on the extended and illuminated 3-D extendable projection surface that is at least one of: (i) synchronized to a predetermined entertainment, (ii) interactively responsive to an action by a person at a venue including the 3-D extendable projection surface, or (iii) responsive to a location of the person within the venue.

2. The system of claim 1, wherein the 3-D extendable projection surface is a 3-D extendable and retractable projection surface, the hardware processor further configured to executed the software code to:
retract the 3-D extendable and retractable projection surface.

3. The system of claim 1, wherein, when extended, the 3-D extendable projection surface forms a conical, a pyramidal, or a frustoconical shape having the extending end as a vertex and the non-extending end as a base.

4. The system of claim 1, wherein, when extended, the extending end of the 3-D extendable projection surface is situated below the non-extending end.

5. The system of claim 1, wherein, when extended, the extending end of the 3-D extendable projection surface is situated above or laterally adjacent to the non-extending end.

6. The system of claim 1, wherein the 3-D extendable projection surface further comprises:
a deformable textured material providing an exterior of the 3-D extendable projection surface.

7. The system of claim 6, wherein the 3-D extendable projection surface further comprises:
a structural element affixed to an inner surface of the deformable textured material at the extending end of the 3-D extendable projection surface;
at least one actuator configured to extend the 3-D extendable projection surface, the at least one actuator including a connector attached to the structural element.

8. The system of claim 6, wherein the 3-D extendable projection surface further comprises:
a plurality of structural elements affixed to an inner surface of the deformable textured material, each of the plurality of structural elements being provided at a different height along the inner surface of the deformable textured material when the 3-D extendable projection surface is extended;
at least one actuator configured to extend the 3-D extendable projection surface, the at least one actuator including a connector attached to at least one of the plurality of structural elements.

9. The system of claim 6, wherein the connector comprises a cable or a rod, and wherein the at least one actuator comprises a rotary actuator or a linear actuator.

10. The system of claim 8, wherein plurality of structural elements are translucent.

11. The system of claim 1, wherein the 3-D extendable projection surface further comprises at least one internal lighting element.

12. The system of claim 1, wherein the 3-D extendable projection surface further comprises an internal object configured to cast a shadow within the 3-D extendable projection surface, the shadow being visible through an exterior of the 3-D extendable projection surface.

13. The system of claim 1, wherein the 3-D visual effect produced on the extended and illuminated 3-D extendable projection surface can be viewed from multiple moving perspectives so as to be viewable in-the-round.

14. A method for use by a system including a computing platform having a hardware processor and a system memory storing a software code, and a projection unit including a three-dimensional (3-D) extendable projection surface having an extending end and a non-extending end, the method comprising:
receiving, by the software code executed by the hardware processor, an activation signal;
extending, in response to receiving the activation signal, the extending end of the 3-D extendable projection surface away from the non-extending end;
illuminating the 3-D extendable projection surface; and
producing on the extended and illuminated 3-D extendable projection surface, by the software code executed by the hardware processor, a 3-D visual effect that is at least one of:
(i) synchronized to a predetermined entertainment, (ii) interactively responsive to an action by a person at a venue including the 3-D extendable projection surface, or (iii) responsive to a location of the person within the venue.

15. The method of claim 14, wherein the 3-D extendable projection surface is a 3-D extendable and retractable projection surface, the method further comprising:
retracting, by the software code executed by the hardware processor, the 3-D extendable and retractable projection surface.

16. The method of claim 14, wherein, when extended, the 3-D extendable projection surface forms a conical, pyramidal, or a frustoconical shape having the extending end as a vertex and the non-extending end as a base situated.

17. The method of claim 14, wherein, when extended, the extending end of the 3-D extendable projection surface is situated below the non-extending end.

18. The method of claim 14, wherein, when extended, the extending end of the 3-D extendable projection surface is situated above or laterally adjacent to the non-extending end.

19. The method of claim 14, wherein the 3-D extendable projection surface further comprises:
a deformable textured material providing an exterior of the 3-D extendable projection surface.

20. The method of claim 19, wherein the 3-D extendable projection surface further comprises:
a structural element affixed to an inner surface of the deformable textured material at the extending end of the 3-D extendable projection surface;
at least one actuator configured to extend the 3-D extendable projection surface, the at least one actuator including a connector attached to the structural element.

21. The method of claim 19, wherein the 3-D extendable projection surface further comprises:
a plurality of structural elements affixed to an inner surface of the deformable textured material, each of the plurality of structural elements being provided at a different height along the inner surface of the deformable textured material when the 3-D extendable projection surface is extended;
at least one actuator configured to extend the 3-D extendable projection surface, the at least one actuator including a connector attached to at least one of the plurality of structural elements.

22. The method of claim 20, wherein the connector comprises a cable or a rod, and wherein the at least one actuator comprises a rotary actuator or a linear actuator.

23. The method of claim 21, wherein plurality of structural elements are translucent.

24. The method of claim 14, wherein the 3-D extendable projection surface further comprises at least one internal lighting element.

25. The method of claim 14, wherein the 3-D extendable projection surface further comprises an internal object configured to cast a shadow within the 3-D extendable projection surface, the shadow being visible through an exterior of the 3-D extendable projection surface.
